(19) United States
(12) Patent Application Publication
(10) Pub. No.: US 2023/0097336 A1
(43) Pub. Date: Mar. 30, 2023

(54) PHASE INTERFEROMETRY DIRECTION FINDING VIA DEEP LEARNING TECHNIQUES

(71) Applicant: BAE Systems Information and Electronic Systems Integration Inc., Nashua, NH (US)

(72) Inventor: Chris Wozny, Waltham, MA (US)

(73) Assignee: BAE Systems Information and Electronic Systems Integration Inc., Nashua, NH (US)

(21) Appl. No.: 17/489,090

(22) Filed: Sep. 29, 2021

(51) Int. Cl. G06N 3/04

(52) U.S. Cl. CPC G06N 3/04

(57) ABSTRACT

A more robust direction finding process that significantly improves processing time and reduce memory requirements relative to the current systems utilizing machine learning techniques to train a deep neural network to compute an azimuth and elevation solution given the channel phase pairs and frequency of measurements of a signal. The disclosed process may be further utilized with legacy direction finding systems to improve the performance and reduce the memory requirements thereof.

### TECHNICAL FIELD

The present disclosure relates to a method of direction finding with improved processing speed and accuracy. More particularly, in one example, the present disclosure relates to processes of phase interferometry direction finding using utilizing a deep neural network to compute an azimuth and elevation solution. Specifically, in another example, the present disclosure relates to processes for phase interferometry direction finding solutions utilizing machine learning techniques to train a deep neural network to compute an azimuth and elevation solution given the channel phase pairs and frequency of measurements of a signal.

### BACKGROUND

The process of locating the source of an emitted signal, which is known as direction finding (DF), is common to many applications. For example, direction finding can be used in navigation, search and rescue, tracking wildlife, and locating illegal transmitters. In military applications, direction finding helps in target acquisition and tracking of enemy locations and movements. Nearly all modern militaries use some form of direction finding to guide their ships, aircraft, troops, and/or munitions in one or more ways. For example, direction finding is the process by which enemy emitters are detected and/or geolocated, thus providing information to military operators as to location and type of emitter being used which can further be used to identify enemy units and/or troops and the movements thereof and to engage or avoid those emitters as desired.

Direction finding is typically done using an antenna or antenna array to detect a signal with an unknown direction of origin. Once a signal is detected, the signal characteristics are currently compared to a database populated with expected signal characteristics from simulated detections. These databases need to be created in advance and stored locally for the DF processor to access during the DF process. Further, the databases of expected signal characteristics can be extremely large, having tens of thousands of data points representing the expected polarization signals at all azimuth angles and all elevations, for multiple types of polarization (e.g. vertical, horizontal, circular, etc.), and for multiple frequencies. Thus, the memory requirement is quite high, often approaching or exceeding 15-20 megabytes of data per antenna. As platforms utilizing direction finding techniques tend to include several arrays having multiple antennas each, the data storage space used is extremely high.

Current DF processes commonly use a technique known as correlation interferometry direction finding (CIDF) to compare the detected signal to the database via one or more correlation equations to determine the best match. This process is viewed as a “brute force” process which requires a large number of calculations using complex numbers and a large number of stored complex antenna array calibration values. As the number of radio frequency (RF) signals increase, direction finding solutions are required for an increasing number of signals, thus often placing performance limits on the DF system based on processing speed and memory requirements.

The size of the databases used in direction finding further increases the processing time for determining a solution. For example, when a signal is detected, it must be measured by multiple antennas, the data from the signal must then be sent to the processor and the characteristics of the signal must be compared to these large databases for each antenna detecting the signal. As measured in processing time, this process can be slow, often taking four or more milliseconds to produce an azimuth and elevation solution.

As systems become more complex and emitters become more agile in their movements and signal masking abilities, both the storage requirements and processing time are expected to increase. In particular, as military technology advances, new emitters have come online that are capable of operation in multiple frequencies of the electromagnetic spectrum and across multiple channels. These advanced emitters are capable of both broadcasting and receiving in short, non-continuous bursts and are considered to be very agile systems that may jump through frequency and dynamic ranges to evade detection while maintaining effective detection capabilities on their own. Most of these modern emitters have a low probability of intercept (LPI) and emit single short radar pulses at varying intervals in their attempts to avoid detection. The sheer number and volume of calculations required by current CIDF based systems can cause the processing time to exceed the detection time, thus making it more difficult to detect and/or properly determine the direction of origin for such signals.

### SUMMARY

The current disclosure addresses these and other issues by providing a more robust direction finding process that significantly improves processing time and reduce memory requirements relative to the current systems utilizing machine learning techniques to train a deep neural network to compute an azimuth and elevation solution given the channel phase pairs and frequency of measurements of a signal. The disclosed process may be further utilized with legacy direction finding systems to improve the performance and reduce the memory requirements thereof.

In one aspect, an exemplary embodiment of the present disclosure may provide a system comprising: a platform; at least one antenna array including a plurality of antennas therein; a receiver; at least one processor capable of executing logical functions in communication with the receiver and the at least one antenna array; and at least one non-transitory computer readable storage medium having instructions encoded thereon that, when executed by the processor, implements operations to determine a direction of origin for an incoming signal, the instructions including: detect an incoming signal; collect signal data from the incoming signal; analyze the collected data using a neural network matrix trained on prior collected antenna data; and generate a direction finding solution representing the direction of origin for the incoming signal. This exemplary embodiment or another exemplary embodiment may further provide wherein the instructions further include: collect antenna data from at least one of actual operation of the antenna array, simulated operation of the antenna array, and theoretical operation of the antenna array prior to the detection of the incoming signal. This exemplary embodiment or another exemplary embodiment may further provide wherein the instructions further include: apply deep learning techniques to train the neural network matrix with the collected antenna data. This exemplary embodiment or another exemplary embodiment may further provide wherein the neural network matrix further comprises: an input layer; at least one hidden layer; and an output layer. This exemplary embodiment or another exemplary embodiment may further provide wherein the input layer further comprises: a plurality of neurons corresponding to at least one of the polarization, phase, amplitude, and frequency of the detected signal. This exemplary embodiment or another exemplary embodiment may further provide wherein the instructions further include: assigning weights and biases to the plurality of neurons of the input layer using back propagation via gradient descent. This exemplary embodiment or another exemplary embodiment may further provide wherein the at least one hidden layer further comprises: at least three hidden layers. This exemplary embodiment or another exemplary embodiment may further provide wherein the neural network matrix further comprises: one 13×1 input layer; four 13×13 hidden layers; and one 13×4 output layer. This exemplary embodiment or another exemplary embodiment may further provide wherein the instructions further include: communicate the direction finding solutions to one or both of the platform and an operator thereof. This exemplary embodiment or another exemplary embodiment may further provide wherein the platform is one of an aircraft, a munition, a sea-based, a land-based vehicle, and a man-portable direction finding system.

In another aspect, an exemplary embodiment of the present disclosure may provide a method of direction finding comprising: detecting an incoming signal with an unknown direction of origin via an antenna array including a plurality of antennas carried by a platform; collecting signal data from the incoming signal; applying a neural network matrix trained on prior collected antenna data to the signal data of the incoming signal; and generating a direction finding solution representing the direction of origin for the incoming signal. This exemplary embodiment or another exemplary embodiment may further provide collecting antenna data from at least one of actual operation of the antenna array, simulated operation of the antenna array, and theoretical operation of the antenna array prior to detecting the incoming signal. This exemplary embodiment or another exemplary embodiment may further provide applying deep learning techniques to train the neural network matrix with the collected antenna data. This exemplary embodiment or another exemplary embodiment may further provide wherein the neural network matrix further comprises: an input layer; at least one hidden layer; and an output layer. This exemplary embodiment or another exemplary embodiment may further provide wherein the input layer further comprises: a plurality of neurons corresponding to at least one of the polarization, phase, amplitude, and frequency of the detected signal. This exemplary embodiment or another exemplary embodiment may further provide further comprising: assigning weights and biases to the plurality of neurons of the input layer using back propagation via gradient descent. This exemplary embodiment or another exemplary embodiment may further provide wherein the neural network matrix further comprises: one 13×1 input layer; four 13×13 hidden layers; and one 13×4 output layer. This exemplary embodiment or another exemplary embodiment may further provide installing the neural network matrix onto at least one non-transitory computer readable storage medium in communication with at least one processor; wherein installing the neural network matrix occurs after training the neural network matrix with the collected antenna data via at least one deep learning technique and prior to detecting the signal with the unknown direction of origin. This exemplary embodiment or another exemplary embodiment may further provide communicating the direction finding solution to one or both of the moving platform and an operator thereof; and taking an action in response to the direction finding solution. This exemplary embodiment or another exemplary embodiment may further provide wherein the platform is one of an aircraft, a munition, a sea-based, a land-based vehicle, and a man-portable direction finding system.

### BRIEF DESCRIPTION OF THE SEVERAL VIEWS OF THE DRAWINGS

Sample embodiments of the present disclosure are set forth in the following description, are shown in the drawings and are particularly and distinctly pointed out and set forth in the appended claims.

FIG. 1A (FIG. 1A) is a schematic view of an exemplary single linear array system according to one aspect of the present disclosure.

FIG. 1B (FIG. 1B) is an overhead schematic view of an exemplary single linear array system installed on a platform according to one aspect of the present disclosure.

FIG. 2A (FIG. 2A) is a schematic view of an exemplary dual orthogonal linear array system according to one aspect of the present disclosure.

FIG. 2B (FIG. 2B) is an overhead schematic view of an exemplary dual orthogonal linear array system installed on a platform according to one aspect of the present disclosure.

FIG. 3A (FIG. 3A) is a schematic view of an exemplary quadrant wing/tail array system according to one aspect of the present disclosure

FIG. 3B (FIG. 3B) is an overhead schematic view of an exemplary quadrant wing/tail array system installed on a platform according to one aspect of the present disclosure.

FIG. 4 (FIG. 4) is a schematic view of an exemplary neural network matrix according to one aspect of the present disclosure.

FIG. 5 (FIG. 5) is a flow chart representing a method of use according to one aspect of the present disclosure.

Similar numbers refer to similar parts throughout the drawings.

### DETAILED DESCRIPTION

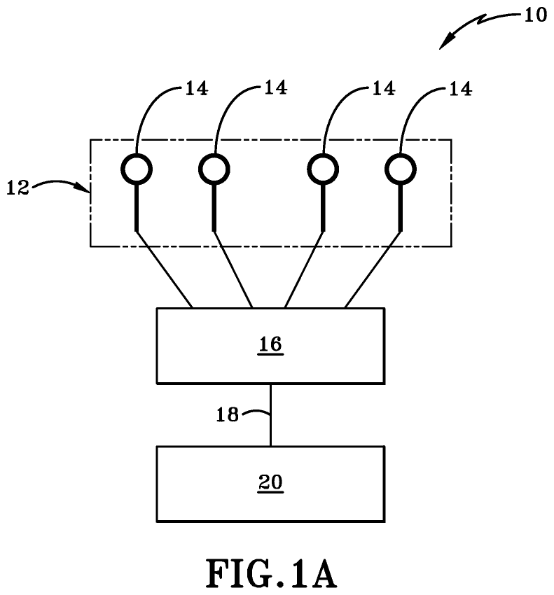

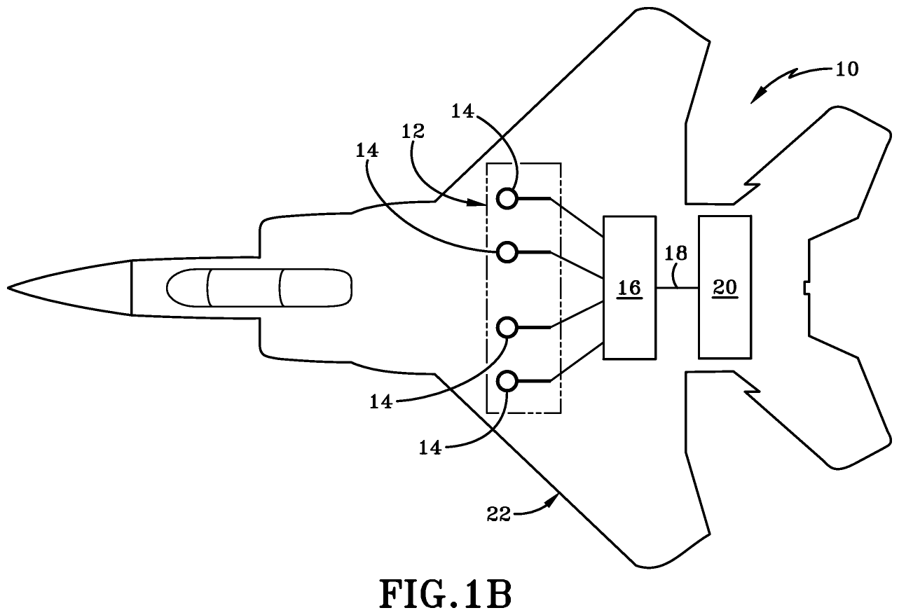

With reference to FIGS. 1A-3B, a direction finding (DF) system is shown and generally indicated at reference 10. DF system 10 may include one or more antenna arrays 12 including one or more antennas 14, at least one receiver 16, at least one output 18, and at least one processor 20. As depicted in FIGS. 1B, 2B, and 3B, DF system 10 may be installed on a platform 22, which is depicted and discussed herein as an aircraft; however, DF system 10 may be installed on a variety of platforms 22 as discussed further herein. DF system 10 may further utilize a neural network matrix construct that may be contained on a non-transitory storage medium in communication with processor 20, as discussed further below. For purposes of this disclosure, the neural network matrix will be generally referenced at 24 and will be understood to be included with processor 20 in the exemplary DF systems 10 shown in the figures and described herein. As discussed further herein, each of these exemplary DF systems 10 may be legacy systems.

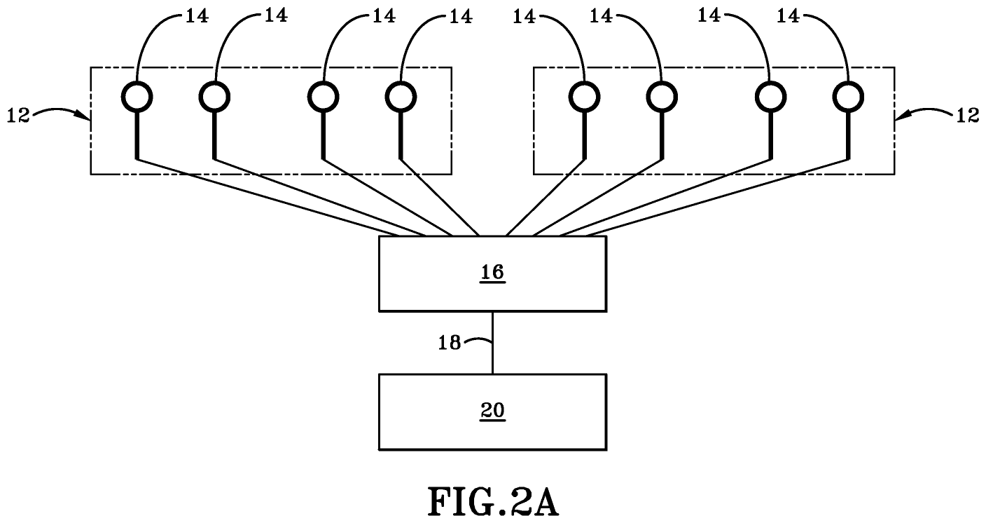

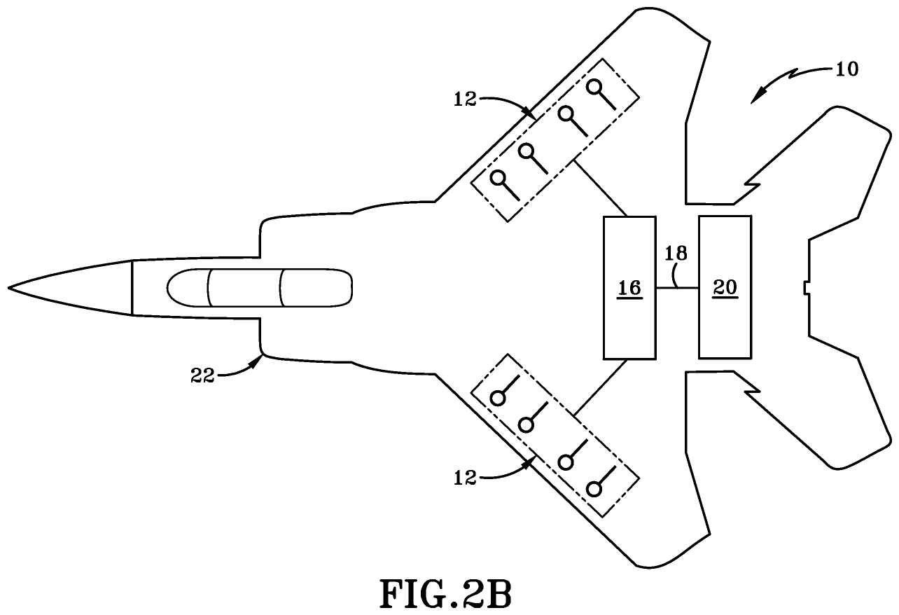

Antenna arrays 12 may include one or more antennas 14 in any configuration and may be installed in any position on platform 22. For example, as depicted in FIGS. 1A and 1B, a single antenna array 12 may be installed on the body of platform 22 and may be arranged with four antennas 14 in a single linear array configuration. Alternatively, as depicted in FIGS. 2A and 2B, two or more antenna arrays 12 may be installed on platform 22, such as on each wing of an aircraft as depicted therein, and each antenna array 12 may have four or more antennas 14 arranged in a dual orthogonal linear array configuration.

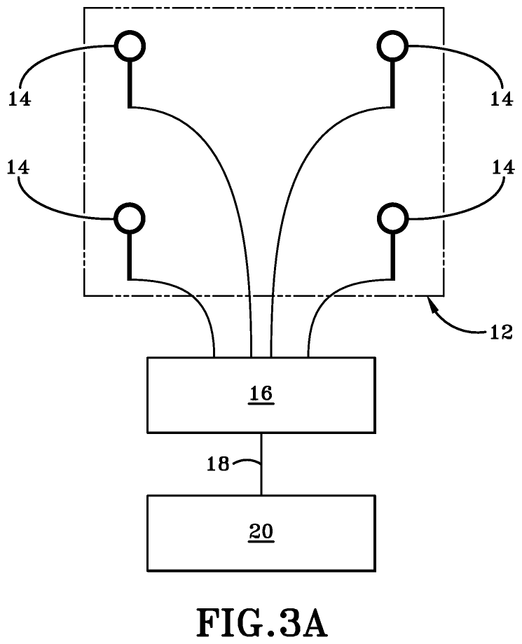

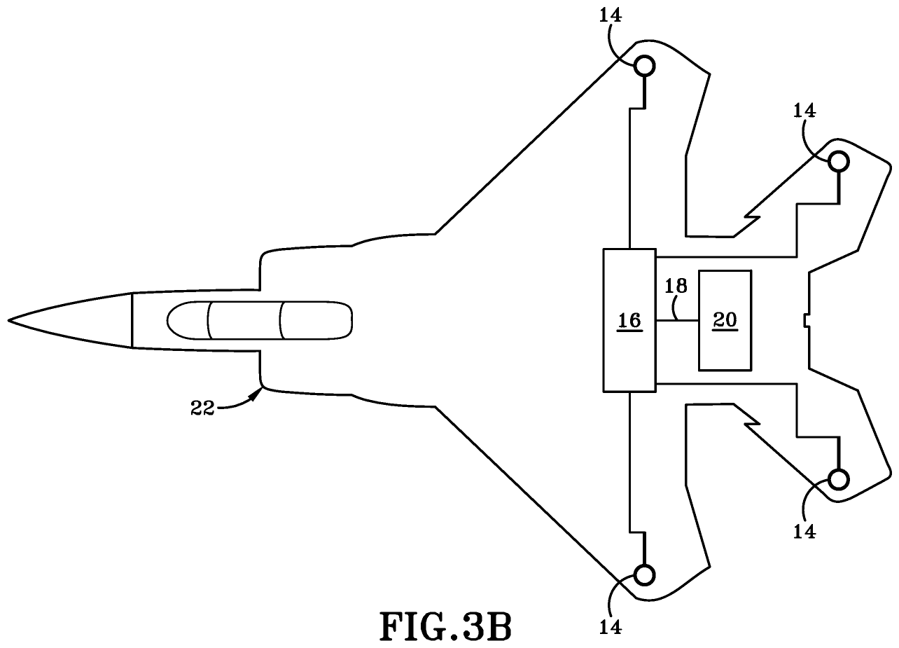

According to another aspect, with reference to FIGS. 3A and 3B, antenna array 12 may include four or more antennas 14 that are installed on platform 22 in a quadrant pattern such as depicted in FIG. 3B with one antenna 14 installed on each wing and each side of the tail of an aircraft as shown therein. These various configurations will be discussed further herein with reference to the operation of DF system 10.

Antennas 14 may be monopole, dipole, or directional antennas or any combination thereof and may be arranged in any desired configuration appropriate for their installation conditions. Although discussed predominantly herein in either linear arrangements or quadrant arrangements, antennas 14 may have any desired configuration, including as arranged in existing legacy configurations on platform 22 as dictated by the specific installation parameters and the type of platform 22 used. For example, one particular antenna 14 arrangement may work better for a particular platform 22 with another antenna 14 arrangement being better suited for a different platform 22. By way of one further non-limiting example, an attack aircraft may be better suited for a particular antenna 14 arrangement while a reconnaissance aircraft may find advantages with different or multiple antenna array 12 arrangements.

Receiver 16 may be a computer or processor or alternatively a computing system that can store and/or execute the process or processes disclosed herein. According to one example, the receiver 16 may be a digital receiver that processes digital signals. According to another example, the receiver 16 may be an analog receiver that processes signals in the analog domain wherein such signals are converted to the digital domain for further processing as discussed herein. Alternatively, receiver 16 may be an intermediary between antenna array 12 and processor 20. According to this aspect, receiver 16 can have a direct connection to processor 20 via the at least one output 18.

Output 18 may be a direct wired connection between receiver 16 and processor 20 that can allow unidirectional or bidirectional communications therebetween. According to another aspect, output 18 may be a wireless datalink between receiver 16 and processor 20 utilizing any suitable wireless transmission protocol.

Processor 20 may be a computer, a logic controller, a series of logics or logic controllers, a microprocessor, or the like that can store and/or execute the process or processes disclosed herein. According to one aspect, processor 20 may further include or be in communication with at least one non-transitory storage medium. According to one aspect, the at least one receiver 16, at least one output 18, and at least one processor 20 may be contained within a single unit and, in connection with the at least one storage medium, can store and/or execute the process or processes disclosed herein. According to another aspect, receiver 16 may be remote from processor 20 and in communication therewith. Although depicted in the figures in a linear arrangement, it will be understood that antenna arrays 12, antennas 14, receivers 16 and/or processors 20 may be placed in any configuration as dictated by the desired implementation and may not be arranged linearly or in any particular order.

Antenna array 12, antennas 14, receiver 16 and/or processor 20 may further be in communication with other components or systems on board the platform 22 such that relevant data may be communicated therebetween. For example, where platform 22 is an aircraft, onboard flight systems may relay data to the receiver 16 and/or processor 20 such as heading, altitude, flight speed, geolocation, and the like. Similarly, receiver 16 and/or processor 20 may communicate data regarding detected signals, DF results and the like to the platform 22, including to an operator or operators thereof. As discussed further below, data regarding detected signals, DF results, and the like that may be communicated to the platform 22 and/or to an operator thereof, may allow responsive actions to be taken by platform 22. For example, an unmanned aircraft, such as a drone or a guided munition, may take automated actions such as steering towards the signal (as in a targeting situation), steering away from the signal (as in evasive maneuvers), jamming the signal, deploying defensive countermeasures, or any other appropriate responsive action. A manned aircraft make take similar responsive action through automatic response systems (such as deploying countermeasures) or may allow the operator/pilot of the aircraft to choose whether or not to employ any appropriate responsive actions.

As mentioned above, platform 22 is discussed and depicted herein as an aircraft, however, it will be understood that platform 22 may be a vehicle of any type that is capable of carrying DF system 10 and performing the necessary steps to determine the direction of a detected signal, as discussed further herein. Thus it will be further understood that platform 22 may be an aircraft, either manned or unmanned, including fixed wing and/or rotary aircraft, a munition, rocket, or other propelled vehicle, a sea-based or land-based vehicle, or may be any suitable stationary installation. According to another aspect, platform 22 may be a man-portable direction finding system.

DF system 10 may include legacy assets, such as legacy antenna arrays 12, antennas 14, receivers 16, outputs 18, and/or processors 20. Any or all of these assets may be legacy assets which may be retrofitted with software or other instructions to accomplish the tasks and features of the present disclosure without significantly increasing size, weight, power, or cost to existing legacy DF systems. The process or processes discussed herein may further be uploaded to existing legacy assets or may be added thereto through the use of an additional memory module, including an additional non-transitory storage medium or through the use of temporary memory devices, such as flash memory or the like. Accordingly, the DF system 10 of the present disclosure may allow existing legacy assets to be used without adjustments thereto.

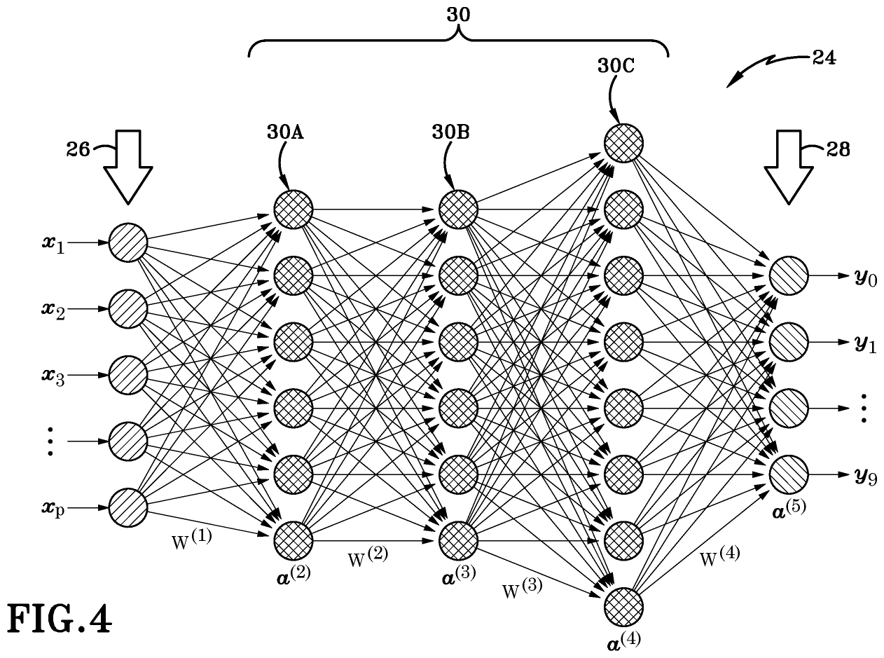

With reference to FIG. 4, an exemplary neural network matrix 24 (or simply neural network 24) is shown and will be described. As seen in FIG. 4, neural network 24 may have an input indicated as the first column as reference 26 culminating in an output indicated as the last column at reference 28. Between input 26 and output 28 may be one or more hidden layers 30. As illustrated and discussed further below, three hidden layers 30A, 30B, and 30C may be utilized to transform input data from the matrix input 26 layer to the output layer 28. Specifically, the inputs may have a plurality of neurons, shown as x₁-xₚ, which may correspond to portions or specific aspects of the collected signal data from a detected signal. According to one non-limiting example the input neurons may represent various data from the detected signal, including, but not limited to, the polarization, phase, amplitude, and/or frequency thereof. These inputs may be passed through hidden layers 30A-30C to generate an output, shown as neurons y₀-y₉ which may be indicative of the direction of the direction of origin for the detected signal. Similarly, hidden layers

Although shown with three hidden layers 30, it will be understood that neural network 24 may include any suitable or desired number of hidden layers 30 as dictated by the desired implementation. According to one example, neural network 24 may include between one and five hidden layers 30, as desired. Input layer 26, along with hidden layers 30, may each provide a matrix operation to the neural network 24. Where there are three hidden layers 30 used, this may result in neural network 24 having four matrix operations to generate a DF solution, as discussed below. Similarly, hidden layers 30 may include any suitable number of neurons therein corresponding to the neurons x of input layer 26 and y of output layer 28.

Having thus described the general configuration and components of DF system 10, the operation and method of use thereof will now be discussed.

As discussed above, platform 22 may be operating in an area of operations with known emitter activity. As it relates to process 100 discussed below, the example of platform 22 being an aircraft either manned or unmanned will be maintained for simplicity of disclosure, however, it will be understood that platform 22 may be any installation capable of carrying and operating the components of DF system 10. While discussed herein as a mobile platform 22, it will be further understood that process 100 and the steps thereof may be performed by stationary and/or fixed installations as well. Further, it will be understood that the operation of platform 22 may be accomplished using the same or similar actions and systems regardless of the configurations of DF system 10 carried thereon. More specifically, three examples have been provided and shown in the figures, particularly FIGS. 1A-3B of aircraft having three different configurations of antenna arrays 12. Process 100 and the operation of platform 22 may have the same or similar steps regardless of which of these three examples, or of other array 12 configurations (including non-aircraft installations), are used.

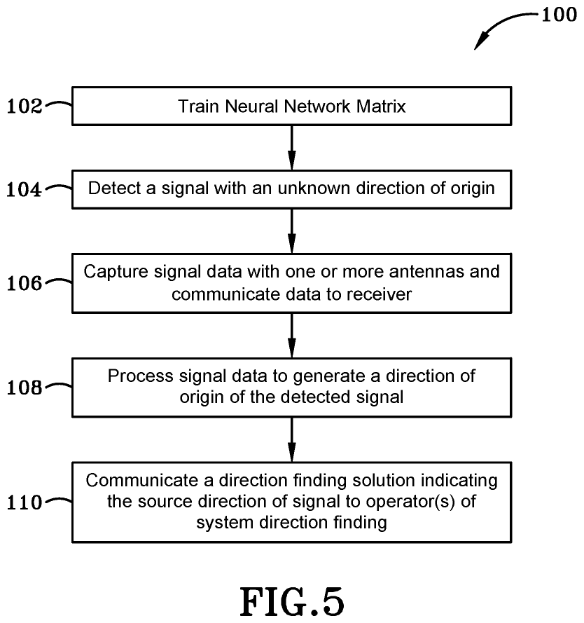

With reference then to FIG. 5, a process for high speed correlation direction finding is shown and generally indicated as a deep learning direction finding process 100 (or simply process 100). This process 100 assumes that the array 12 has been properly installed and calibrated according to the desired implementation. Where current DF processes would create and store a database of expected signal characteristics as the next step in process 100, the present process differs in that the database is not required. Instead, the neural network 24 performs the necessary calculations and provides a DF result. Further, for any given arrangement of antennas 14 within an array 12, the neural network 24 need only be setup once and stored in the memory of the processor 20 within DF system 10. Therefore, while the first step 102 in process 100 is to train and install the neural network 24, as discussed further herein, once that step is performed and the neural network 24 is installed with DF system 10, the process 100 may be performed to determine the direction of origin for a detected signal beginning with step 104 as provided herein. Only when utilizing a differently configured antenna 14 and or array 12 would step 102 need to be repeated for a given DF system 10.

Accordingly, the steps of process 100 will now be provided as an overview of the process 100, with the individual steps discussed further below. As mentioned above, step 102 includes training and storing the neural network 24 in DF system's 10 memory. Once equipped with the neural network 24, DF system 10 may be operated on platform 22 as follows: First, in step 104, an emitted pulse or signal may be detected. Step 106 may then provide that data relating to the signal may be captured by the antennas 14 of antenna array 12 and communicated to receiver 16. Receiver 16 may then deliver the signal data through output 18 to processor 20 for further processing. The processing and communication of the signal data between the receiver 16 and processor 20 is indicated as step 108 in process 100. This processing step 108 may utilize the neural network 24, as described further below, to provide a DF solution, which may be an indication of the direction of origin for the detected signal relative to platform 22. The DF solution may be further communicated to an operator(s) of platform 22 as discussed further herein. The generation and communication of the DF solution is indicated as step 110 in process 100.

It will be understood that process 100 may be a general method of use for DF system 10, however, process 100 may differ from current DF processes in several aspects. Accordingly, each individual step in process 100 will now be further discussed in more detail.

In order to train the neural network 24, antenna data (also referred to as calibration data) for the specific arrangement of antennas 14 in array 12 needs to be collected. If the system/array 12 being used has previously been used for DF processes, particularly CIDF processes, this antenna data would likely already exist as the database of expected signal characteristics. If the array 12 has not been previously used in DF processes, the antenna data must be collected anew.

Either way, the collection of antenna data is expected to be performed prior to “real world” operation of DF system 10. When collecting antenna data for the array 12, the antennas should have a calibration that is relative to the same reference antenna 14 as will be the reference antenna 14 used for detection and measuring the actual signal. For example, if operation of DF system 10 will be done relative to a specific antenna 14 within array 12, process 100 assumes that the calibration and data collection are likewise performed relative to that same antenna. While there are known processes that allow for post calibration creation of the reference antenna, this reference antenna should be the same as the expected usage reference antenna prior to collecting the antenna data. By way of a simplified, but non-limiting example, if a linear array 12 with four antennas 14 is being used, it may number the antennas 14 from one to four, left to right (for example, in FIG. 1A). In collecting antenna data, if the first antenna 14 is the operational reference point, the calibration should be performed and the collected relative to the first antenna 14.

Assuming the use of the same reference antenna in the array, the collection of antenna data may include a series of signal measurements taken by the array 12, or a simulated version thereof, prior to being employed into an active detection environment. Specifically, an array 12 is installed (or simulated) in the environment in which it is intended to operate. Then, a series of signals can be emitted towards the array 12 from multiple angles which can then be detected by the antennas 14 of array 12. The signals directed by array 12 during the creation and training of neural network 24 can include multiple signals having different polarizations, phases, amplitudes, and/or frequencies. By way of one non-limiting example, the data collected may contain expected signal characteristics from signals having vertical and horizontal polarizations emitted at intervals of every five degrees azimuth around the array 12. According to another aspect, signals can be emitted and the characteristics recorded at predetermined intervals in both azimuth and elevation.

According to one aspect, the antenna data may be collected using simulations of array 12 in the installation environment. These simulations can include 3-D modelling, scale models, partial installations, computer generated simulations, or other known modelling techniques. According to another aspect, array 12 can be installed in the actual installation environment and used to collect the required antenna data. For example, an array 12 can be installed on an aircraft which can be flown in an operational environment while signals are emitted and detected to collect the antenna data.

The collection of antenna data is contemplated to be performed prior to implementation of the present process 100, but is also contemplated to be performed only once per configuration of array 12. The collection of antenna data is similar or potentially identical to collection of data prior to generating a database of expected signal characteristics as performed with current CIDF systems; however, here the collected antenna data here may then be utilized to train the neural network matrix 24, discussed further below. Further, according to one example, the neural network 24 may be trained using theoretical phase data rather than collected antenna data. Theoretical training of neural network 24 may save upfront time and costs as the training of neural network 24 may be theoretical, eliminating the need for simulated or actual collection of antenna data. Additionally, the neural network is further parallelizable. In particular, increasing the number of columns of input data (i.e. adding additional input layers 26) may allow more DF solutions to be batched together.

According to one aspect, neural network 24 may have a 13×1 input layer 26, four 13×13 hidden layers 30 and one 13×4 output layer 28. This may allow current data requirements to be compressed. Specifically, current CIDF systems typically utilize 24 megabytes (MB) of antenna calibration data per antenna which may be compressed down to three (3) kilobytes (KB) of weights and biases data to run neural network 24, as discussed further below.

Once the antenna data is collected, deep learning techniques may be utilized to train the neural network 24. Specifically, antenna data, be it theoretical or actual collected antenna data, may be fed into or otherwise provided to neural network 24 at the input layer 26. At this layer, each data point may be assigned a weight or bias which may then further propagate through the hidden layers 30 before providing a DF solution at output layer 28. As more data is provided to neural network 24, the faster the network 24 may learn and the accuracy may further increase. Having trained the neural network on antenna data, the network may then be downloaded or otherwise installed into memory of processor 20 to allow the network 24 to be used in real world and/or actual DF processes.

According to one aspect, as mentioned above, the memory requirement for neural network 24 may be approximately 1/100^{th} of one percent of the current memory requirements for CIDF processes. According to this example, while current CIDF processes may utilize up to 24 MB of data per antenna, the presently trained neural network 24 may utilize as little as 3 KB. Similarly, the processing throughput is increased utilizing neural network 24 as opposed to current CIDF processes. Specifically, neural network 24 may have approximately 20 lines of software code required to perform the matrix multiplications while current CIDF processes use approximately 2,000 or more lines of code to correlate measured data to the calibration file, i.e. the database of expected signal characteristics to generate a DF solution.

In particular, as it relates to processing throughput, current CIDF execution times, which grow exponentially with an increase in antenna calibration data, typically requires approximately four milliseconds to compute a DF solution. Contrast this with the present matrix 24 where the use and operation thereof may reduce the required processing time by a factor of approximately 100 to result in a 43 microseconds approximate processing time. Accordingly, by repeating five matrix multiplication and addition functions within the neural network 24 to convert input and output data between degrees and complex representation may provide that DF system 10 utilizes only 1/100^{th} of one percent of the memory and processes almost 100 times faster than current CIDF systems.

With regards to performance, the resulting DF solution provided by a neural network matrix 24 utilizing the deep learning direction finding process 100 described herein may have a similar azimuth performance accuracy compared to current CIDF processes while further providing improved accuracy in elevation DF solutions. In particular, while offering similar accuracy on azimuth only (or on the azimuth portion of azimuth/elevation) DF solutions, the present process 100 may provide a 1.5× improvement in the elevation plane.

Once the antenna data has been collected and the neural network 24 has been trained and installed within DF system 10, the platform 22 carrying DF system 10 may be operated according to its normal or directed use. Accordingly, during the operation of platform 22, process 100 may continue with the detection of an emitted pulse or signal, most commonly in the form of a radio frequency (RF) signal, from an emitter having an unknown direction of origin. This detection of an emitted signal is indicated as reference 104 in process 100.

The signal may be detected as it moves across or otherwise encounters the antennas 14 of the one or more antenna arrays 12 and data relating to the signal may be captured thereby and provided to receiver 16 via the at least one output 18. This data captured by the antennas 14 may include at least one or more of the phase, amplitude, magnitude, frequency, pulse length, and repeatability of the signal. The capturing and communication of the signal data is indicated in process 100 as step 106.

At its most basic operational level, receiver 16 may translate the signal data into a form usable by processor 20 to determine the direction of origin of the signal. This PDW may then be delivered through output 18 to processor 20 for further processing. The processing step is indicated as reference 108 in process 100 and may be one of the key aspect as to how process 100 differs from current DF processes (including CIDF), as discussed further below. Specifically, as discussed above, the processing step indicated as reference 108 in process 100 may differ from current CIDF or other DF processes in the usage of the neural network 24 to provide the DF solution. Specifically, when a signal is detected, the data relating to that signal may be captured and provided to the input layer 26 of neural network 24. The set of weights and biases at the input layer 26 may be provided using back propagation via gradient descent, and neural network 24 may then produce a DF solution.

Again, as mentioned above, the neural network 24, via its deep learning direction finding techniques, is able to compute an analytical solution utilizing less memory, shorter operational codes, and faster processing times. Further, the deep learning neural network matrix 24 may realize these benefits while maintaining a similar level of accuracy in the azimuth plane as current CIDF processes, while simultaneously providing increased accuracy in the elevational plane.

Once the DF solution is determined in step 108, that solution may be communicated to the platform 22 and/or to an operator thereof, which may allow responsive actions to be taken by platform 22. For example, platform 22 may include additional systems/processing to provide more information about the emitter producing the detected signal. Such information may be useful in determining if the emitter is a threat to platform 22 and/or its operations in the region. The communication of the DF signal to the platform 22 and/or operator(s) thereof may further allow a decision to alter the operation of platform 22 to be made. According to one aspect, as discussed previously herein, determining the DF solution may allow platform 22 and/or the operator(s) thereof to perform automated actions such as steering towards the signal (as in a targeting situation), steering away from the signal (as in evasive maneuvers), jamming the signal, deploying defensive countermeasures, or any other appropriate responsive action.

Emitters in an area of operation are known to generate a pulse of electromagnetic energy, such as radar, in an effort to monitor, locate, and/or identify any aircraft or other units operating nearby. Most commonly, this is in the form of a RF pulse/signal. In order to maintain agility and minimize the risk of being intercepted, these emitters typically emit a short length pulse that can utilize the motion of the operating unit to gather information about that unit. For example, a radar pulse may be generated for a period of time that is sufficiently long enough to gather information about the unit operating nearby. Common information determined from these pulses may include whether the unit is friend or foe, what type of unit it is, e.g. if the unit is an aircraft, what type of aircraft it is, the speed, heading, and/or direction of origin. Further, the emitter may use the pulse data to determine the number of units as well as their formation, spacing, and similar data. The use of short, non-continuous burst may allow an emitter to gather this information without revealing too much information about the emitter itself.

These short duration pulses may be detected by DF system 10, but as they are limited in duration, the speed at which DF system 10 operates, i.e. the speed at which the system 10 can determine the direction of origin for these pulses, becomes increasingly important. Thus, the improved processing speed and reduced memory requirements of DF system 10 and process 100 described herein may provide a significant advantage to a platform 22 utilizing the same.

Further, as these pulses may represent a threat to the platform 22 carrying DF system 10, the accuracy of the DF result is equally, if not more important as an incorrect result could result in negative outcomes. For example, when platform 22 is an unmanned aircraft, providing an incorrect DF result may cause that aircraft to steer towards a threat, which may ultimately result in the loss of the platform 22, according to this example. Accordingly, while operating faster and with reduced memory requirements provides a benefit to platforms 22 utilizing DF system 10 and process 100, the use of the DF system 10 and process 100 may further provide these benefits while maintaining similar azimuth performance and increased elevation performance relative to current CIDF processes.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A system comprising:
a platform;
at least one antenna array including a plurality of antennas therein;
a receiver;
at least one processor capable of executing logical functions in communication with the receiver and the at least one antenna array; and
at least one non-transitory computer readable storage medium having instructions encoded thereon that, when executed by the processor, implements operations to determine a direction of origin for an incoming signal, the instructions including:
detect an incoming signal;
collect signal data from the incoming signal;
analyze the collected data using a neural network matrix trained on prior collected antenna data; and
generate a direction finding solution representing the direction of origin for the incoming signal.

2. The system of claim 1 wherein the instructions further include:
collect antenna data from at least one of actual operation of the antenna array, simulated operation of the antenna array, and theoretical operation of the antenna array prior to the detection of the incoming signal.

3. The system of claim 2 wherein the instructions further include:
apply deep learning techniques to train the neural network matrix with the collected antenna data.

4. The system of claim 1 wherein the neural network matrix further comprises:
an input layer;
at least one hidden layer; and
an output layer.

5. The system of claim 4 wherein the input layer further comprises:
a plurality of neurons corresponding to at least one of the polarization, phase, amplitude, and frequency of the detected signal.

6. The system of claim 5 wherein the instructions further include:
assigning weights and biases to the plurality of neurons of the input layer using back propagation via gradient descent.

7. The system of claim 4 wherein the at least one hidden layer further comprises:
at least three hidden layers.

8. The system of claim 4 wherein the neural network matrix further comprises:
one 13×1 input layer;
four 13×13 hidden layers; and
one 13×4 output layer.

9. The system of claim 1 wherein the instructions further include:
communicate the direction finding solutions to one or both of the platform and an operator thereof.

10. The system of claim 1 wherein the platform is one of an aircraft, a munition, a sea-based, a land-based vehicle, and a man-portable direction finding system.

11. A method of direction finding comprising:
detecting an incoming signal with an unknown direction of origin via an antenna array including a plurality of antennas carried by a platform;
collecting signal data from the incoming signal;
applying a neural network matrix trained on prior collected antenna data to the signal data of the incoming signal; and
generating a direction finding solution representing the direction of origin for the incoming signal.

12. The method of claim 11 further comprising:
collecting antenna data from at least one of actual operation of the antenna array, simulated operation of the antenna array, and theoretical operation of the antenna array prior to detecting the incoming signal.

13. The method of claim 12 further comprising:
applying deep learning techniques to train the neural network matrix with the collected antenna data.

14. The method of claim 11 wherein the neural network matrix further comprises:
an input layer;
at least one hidden layer; and
an output layer.

15. The method of claim 14 wherein the input layer further comprises:
a plurality of neurons corresponding to at least one of the polarization, phase, amplitude, and frequency of the detected signal.

16. The method of claim 15 further comprising:
assigning weights and biases to the plurality of neurons of the input layer using back propagation via gradient descent.

17. The method of claim 14 wherein the neural network matrix further comprises:
one 13×1 input layer;
four 13×13 hidden layers; and
one 13×4 output layer.

18. The method of claim 11 further comprising:
installing the neural network matrix onto at least one non-transitory computer readable storage medium in communication with at least one processor;
wherein installing the neural network matrix occurs after training the neural network matrix with the collected antenna data via at least one deep learning technique and prior to detecting the signal with the unknown direction of origin.

19. The method of claim 11 further comprising:
communicating the direction finding solution to one or both of the moving platform and an operator thereof; and
taking an action in response to the direction finding solution.

20. The method of claim 11 wherein the platform is one of an aircraft, a munition, a sea-based, a land-based vehicle, and a man-portable direction finding system.
